(19) United States
(12) Patent Application Publication
(10) Pub. No.: US 2003/0099067 A1
(43) Pub. Date: May 29, 2003

(54) Disc drive head positioned by multiple dipole Halbach motor

(76) Inventor: Waleed Ahmed Farahat, St. Louis Park, MN (US)

Correspondence Address: David C. Bohn, WESTMAN CHAMPLIN & KELLY, International Centre, Suite 1600, 900 South Second Avenue, Minneapolis, MN, 55402-3319, US

(21) Appl. No.: 10/122,512

(22) Filed: Apr. 11, 2002

Related U.S. Application Data
(60) Provisional application No. 60/331,820, filed on Nov. 20, 2001.

(51) Int. Cl. G11B 5/55

(52) U.S. Cl. 360/264.3

(57) ABSTRACT

A disc drive includes a motor that positions a head assembly on a disc surface. The motor comprises a central stator assembly that includes coils arranged on a yoke. The coils provide multiple stator current loops on the central stator assembly. The motor also comprises a rotor assembly that includes a permanent magnet ring. The permanent magnet ring is rotatably arranged around the central stator assembly and provides multiple rotor dipole magnetic fields that cross the current loops. The motor includes a beam coupled between the permanent magnet ring and the head assembly.

### CROSS-REFERENCE TO RELATED APPLICATIONS

This application claims priority benefits from U.S. Provisional Application No. 60/331,820 titled “Multiple-dipole Halbach array voice coil motor,” filed Nov. 20, 2001 and identified as Docket Number STL10580.01.

### FIELD OF THE INVENTION

The present invention relates generally to disc drive data storage devices, and more particularly without limitation to motors for positioning heads in disc drive data storage devices.

### BACKGROUND OF THE INVENTION

Disc drives store data bits in the form of concentric tracks on a disc surface. Increasing the storage areal density on a drive can be achieved by reducing the size of bits in the circumferential direction, as well as increasing the number of tracks in the radial direction (track density).

Increasing track density (kilotracks per inch or kTPI) capability of disc drives, head testers, and servo-track writers, requires more precise positioning of the read/write head with respect to disc tracks. Some errors in position of the head on a given track center are random, and are due to the contribution of several sources. Those contributions must be limited by a budget that defines the overall allowable limits to off-track motion for a given capability. This is known as track misregistration (TMR) budgeting.

Using current voice coil motor (VCM) actuators, a significant portion of the TMR budget is used up by translational vibration modes of the VCM associated with the pivot bearings. These modes are excited since the mechanics of the actuator produce translational forces as a by-product of the torque generating mechanics.

A method and apparatus are needed that provide rapid and precise dynamic positioning of heads on discs.

### SUMMARY OF THE INVENTION

Disclosed are a method for making a disc drive and a disc drive. The disc drive comprises a head assembly that includes a head that accesses a disc surface and a strut that extends from a strut proximal end to a strut distal end that engages the head. The disc drive also includes a motor that positions the head assembly.

The motor comprises a central stator assembly that includes coils arranged on a yoke. The coils are arranged as multiple stator current loops on the central stator assembly. The motor also comprises a rotor assembly that includes a permanent magnet ring. The permanent magnet ring is rotatably arranged around the central stator assembly and provides multiple rotor dipole magnetic fields that are inside the permanent magnet ring and that cross the current loops. The motor includes a beam coupled between the permanent magnet ring and the strut proximal end.

The disclosed motor can also be used in other data storage control and actuation applications, such as head testing and servo-track writing. These and various other features as well as advantages which characterize embodiments of the present invention will be apparent upon reading of the following detailed description and review of the associated drawings.

### BRIEF DESCRIPTION OF THE DRAWINGS

FIG. 1 illustrates a top isometric view of a PRIOR ART disc drive.

FIG. 2 schematically illustrates a PRIOR ART radial actuator assembly including a voice coil.

FIG. 3 schematically illustrates a disc drive including a multiple dipole motor.

FIG. 4 illustrates a cross-sectional view of a multiple dipole motor.

FIG. 5 illustrates a yoke for a central stator assembly.

FIG. 6 illustrates a central stator assembly.

FIG. 7 illustrates a cross-sectional view of a rotor magnetic field distribution in a 2 dipole motor.

FIG. 8 illustrates a cross-sectional view of a rotor magnetic field distribution in a 3 dipole motor.

FIG. 9 illustrates variation of torque constants for dipole motors as a function of a number of dipoles and a number of magnet segments in a ring.

### DETAILED DESCRIPTION OF ILLUSTRATIVE EMBODIMENTS

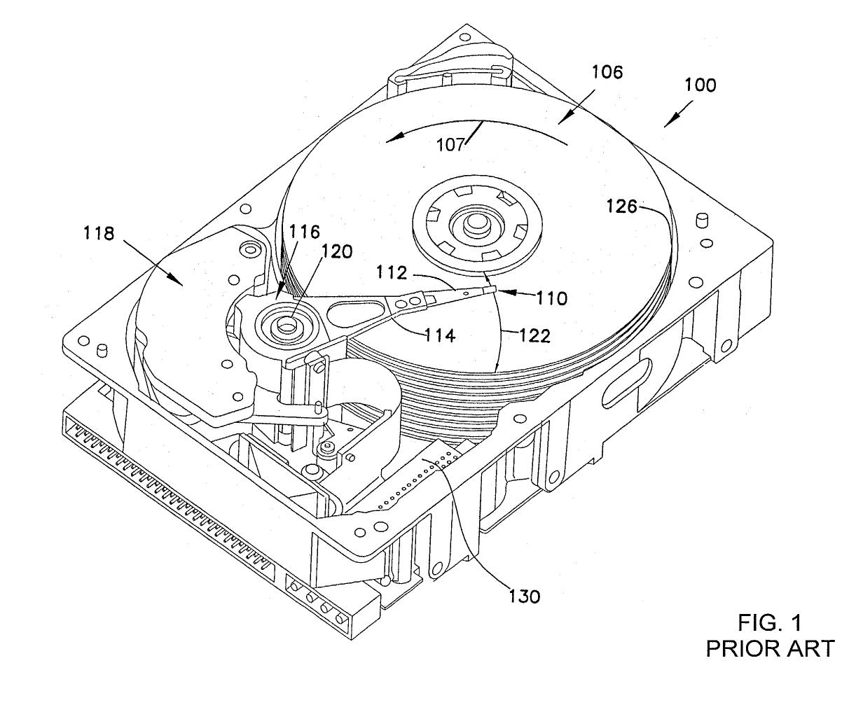

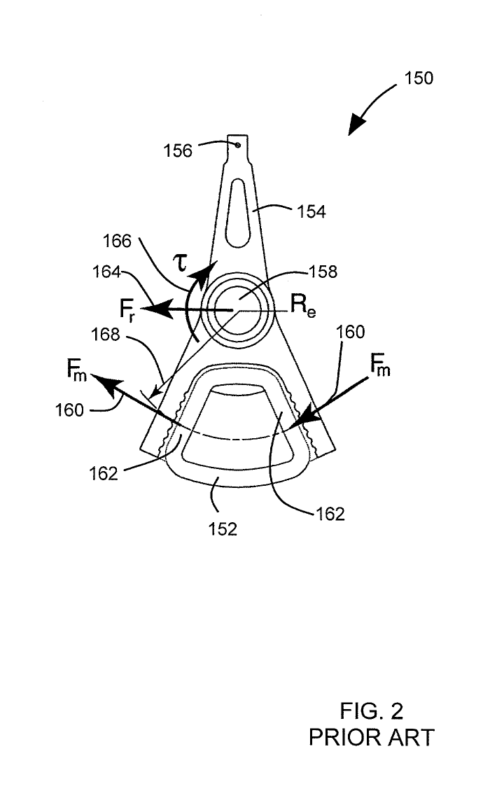

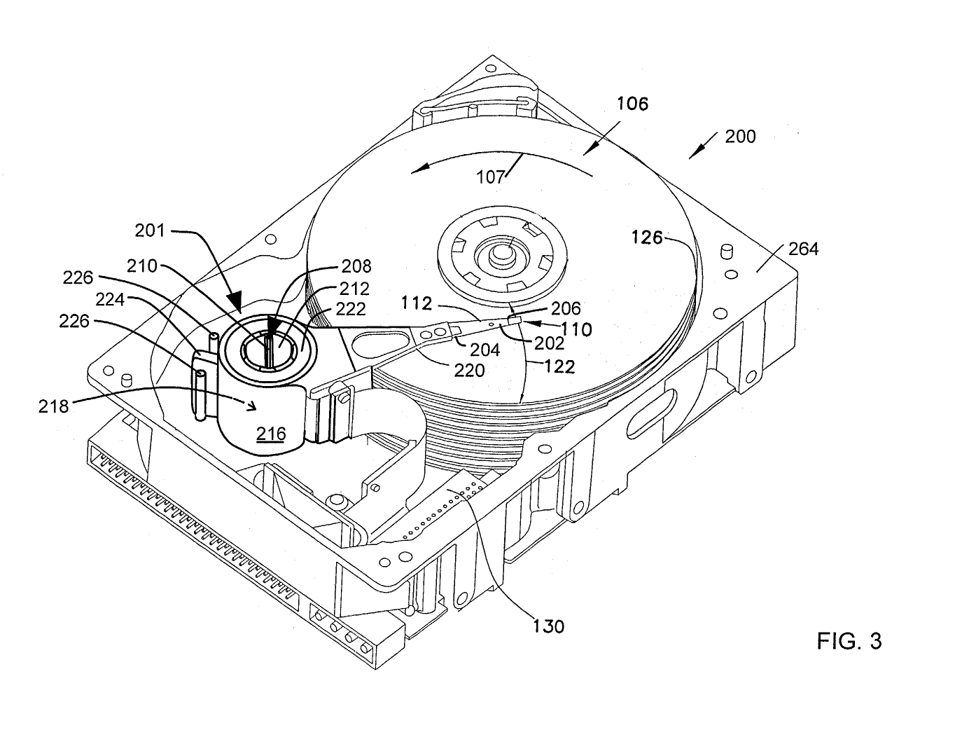

In the embodiments illustrated below in FIGS. 3-9, a moving voice coil motor (described in FIGS. 1-2) is eliminated and a fixed coil motor is disclosed that includes fixed coils mounted in fixed positions on a central stator assembly and also includes a permanent magnet rotor that produces a multiple dipole rotor magnetic field that crosses current loops in the fixed coils. The fixed coil motor produces a symmetrical, (true torque) force on the permanent magnet rotor. Undesired translational vibrations are, in theory, eliminated, and the head is rapidly and precisely positioned on the disc. Track misregistration is reduced and higher track densities (kTPI) can be used.

FIG. 1 illustrates an embodiment of a disc drive 100 including a slider or head 110 that includes one or more read/write transducers. Disc drive 100 includes a disc pack 126 having storage media surfaces (disc surfaces) 106 that are typically layers of magnetic material. The disc pack 126 includes a stack of multiple discs. A head assembly 112 includes the head 110 with a read/write transducer for each stacked disc. Disc pack 126 is spun or rotated as shown by arrow 107 to allow head assembly 112 to access different rotational locations for data on the storage surfaces 106 on the disc pack 126.

The head assembly 112 is actuated to move radially, relative to the disc pack 126, as shown by arrow 122 to access different radial locations for data on the disc surfaces 106 of disc pack 126. Typically, the actuation of the head assembly 112 is provided by a voice coil motor 118. Voice coil motor 118 includes a rotor 116 that pivots on axle 120 and an arm or beam 114 that actuates the head assembly 112. The head assembly 112 presses down on a central gimbal point on the head 110, providing a load force that holds the head 110 in close proximity to the storage surface 106. One or more read/write transducers are deposited on the head 110 and fly above the disc surface 106 at a fly height. A circuit at location 130 provides an electric current to the voice coil motor 118 to control the radial position of the head 110 and electrically interfaces read/write transducers on heads 110 with a computing environment.

FIG. 2 schematically illustrates a PRIOR ART radial actuator assembly 150 including a voice coil 152 and arms (also called a beams) 154 that are arranged to connect with head assemblies (not illustrated in FIG. 2) at 156. The radial actuator assembly 150 pivots on an axle 158. A control current passes through the voice coil 152. The control current in the voice coil interacts with a magnetic field from permanent magnets (not illustrated in FIG. 2) to generate forces Fm 160 on the two radial segments 162 of the voice coil 152. The forces Fm 160 are asymetrically arranged on the same side of the pivot 158 (rather than being distributed around the pivot 158 in a radially symmetrical manner). The radial actuator assembly 150 has a significant inertial load on the opposite side of the axle 158 due to the masses of the beams 154 and the attached head assemblies. The asymetrical forces 160 and the inertial load cause a lateral reaction force Fr 164 in the axle 158 and also cause a torque τ 166 on the radial actuator assembly 150.

The lateral reaction force Fr 164 excites translational modes of vibration in radial actuator assembly 150. The vibration causes an undesired increase in non-repeatable runout (NRRO). Additionally, the lateral reaction forces Fr may couple in with vibration modes associated with the voice coil 152, and hence further increase the TMR due to coil vibration modes. The problems associated with the voice coil motor arrangements described in FIGS. 1-2 are greatly improved by eliminating the moving voice coil arrangement and replacing it with an arrangement (described below in connections with FIGS. 3-10) where multi-dipole coils are part of a fixed central stator and a multi-dipole permanent magnet ring rotates around the central stator. The magnetic forces on the permanent magnet ring are symmetrical about a central axis and there is thus a great reduction in the excitation of translational vibration modes. The arrangements described below provide a true torque motor for positioning a head over a surface of a disc. In the motor described below, the magnetic forces on the central stator assembly are primarily rotational forces rather than translational forces. The off-center inertia of the head assembly and beam is counterbalanced with a counterweight. The kTPI capability of the actuator is increased due the elimination of a significant portion of the TMR budget.

FIG. 3 schematically illustrates a disc drive 200 including a multiple dipole motor 201. Disc drive 200 is similar to the disc drive 100 illustrated in FIG. 1, however, disc drive 200 includes the multiple dipole motor 201 instead of a voice coil motor 118. Reference numbers used in FIG. 2 that are the same as reference numbers used in FIG. 1 identify the same or similar parts.

The disc drive 200 comprises one or more discs 126 having disc surfaces 106. For each disc surface 106, there is a head assembly 112 that includes a head 110 accessing the disc surface 106 and a strut 202 that extends from a strut proximal end 204 to a strut distal end 206 that engages the head 110.

The motor 201 comprises a central stator assembly 208 that includes a yoke 210. The yoke 210 is preferably formed of stainless steel. Coils 212 are arranged on the yoke 210 to provide multiple stator current loops on the central stator assembly 208. Coils 212 are preferably formed of copper alloy wires or tapes.

The motor 210 also includes a rotor assembly 216 that includes a permanent magnet ring 218 (hidden from view in FIG. 3) that is rotatably arranged around the central stator assembly 208. The permanent magnet ring 218 provides multiple rotor dipole magnetic fields that are inside the permanent magnet ring and that cross the current loops. The rotor assembly 216 also includes a beam 220 coupled between the permanent magnet ring 218 and the strut proximal end 204.

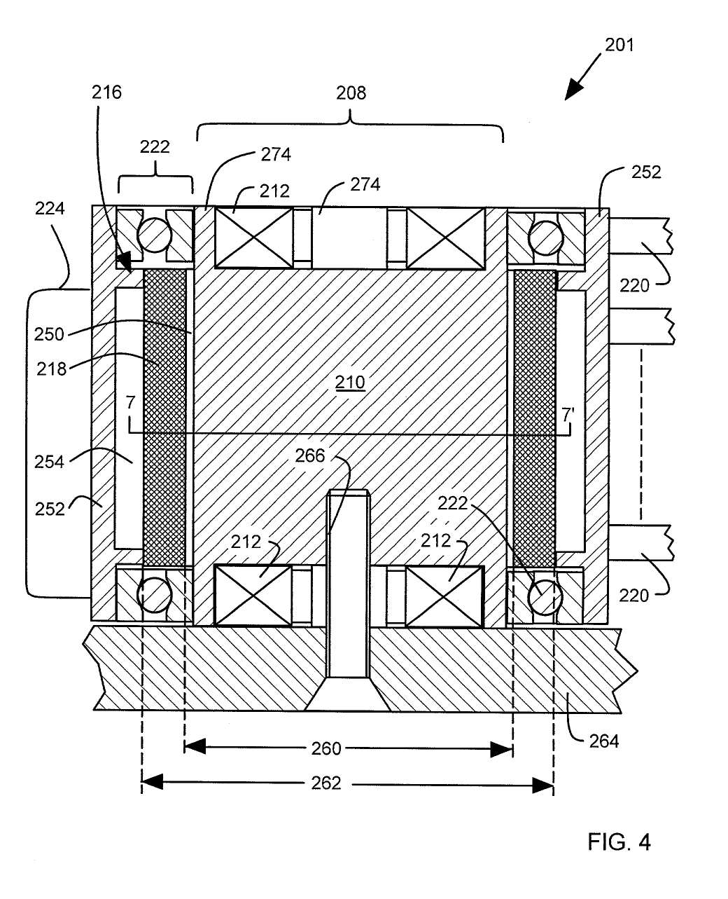

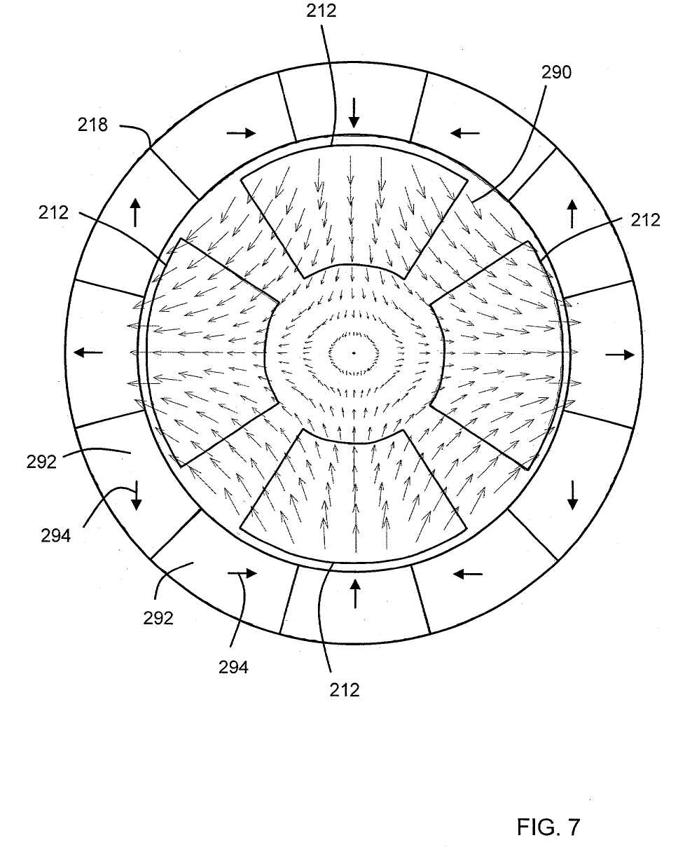

Construction details of the motor 210 are explained in greater detail below in connection with FIGS. 4-6. The arrangement of the permanent magnet ring 218 and associated dipole magnetic fields are explained in more detail below in connection with FIGS. 7-9.

The rotor assembly 216 is preferably supported to rotate about the central stator assembly 208 by one or more bearings 222 that rotatably supports the rotor assembly 216 on the central stator assembly 208. The rotor assembly 216 includes a counterweight 224 that rotationally balances the rotor assembly 216. The counterweight 224 is positioned and sized to dynamically balance the rotor assembly 216 about its rotational axis.

In a preferred arrangement, the permanent magnet ring 218 is constructed as a Halbach ring that produces multiple dipole fields in a central space surrounded by the ring. Halbach rings are known, for example, from “DESIGN OF PERMANENT MULTIPOLE MAGNETS WITH ORIENTED RARE EARTH COBALT MATERIAL,” K. Halbach, Nuclear Instruments and Methods, 169, p. 1-10 (1980), and “Magnetomechanics of Internal-Dipole, Halbach-Array Motor/Generators,”0 John R. Hull et al., IEEE Transactions on Magnetics, Vol. 36, No. 4, July 2000, pp. 204-2011.

The permanent magnet ring 218 preferably comprises magnetically hard material such as neodymium iron boride alloy, samarium cobalt alloy, platinum cobalt alloy or samarium cobalt alloy. Other known magnetically hard materials can be used as well.

The disc drive 200 preferably comprises mechanical stops 226 that engage the rotor assembly 216 at first and second rotational movement limits. The mechanical stops 226 are preferably positioned to limit rotational movement to 30 degrees or less.

The motor 201 is explained in more detail below in connection with FIG. 4.

FIG. 4 illustrates a cross-sectional view of the multiple dipole motor 201, and reference numerals in FIG. 4 that are the same as reference numerals used in FIG. 3 identify the same parts. The central stator assembly 208 is separated by an air gap 250 from the permanent magnet ring 218. The bearings 222 are mounted between the yoke 210 and a pivot housing 252. Pivot housing 252 is integrally formed as a single component with the counterweight 224 and one or more of the beams 220. An annular space 254 between the permanent magnet ring 218 and the pivot housing 252 can be left empty or can be filled with a band of magnetic material that surrounds the permanent magnet ring 218. The band of magnetic material can support the permanent magnet ring 218 and also magnetically shield the adjacent discs 126 from the permanent magnet ring 218. A preload force can be exerted on the bearings 222 by cone ring shaped (Belleville) preload springs or preload screws.

A thickness ratio of the permanent magnet ring 218 affects the torque characteristic of the motor as well as the rotational inertial of the rotor assembly. There is an objective to increase torque and decrease inertia. As the thickness ratio increases, the torque increases as desired, however, the rotational inertia does not decrease, but instead increases undesirably. The increased torque improves performance, while the increased inertial reduces performance. A thickness ratio is desired that provides a good compromise between these conflicting objectives. In a preferred arrangement, the permanent magnet ring 218 has an inner ring diameter 260 and an outer ring diameter 262 and a thickness ratio of the outer ring diameter 262 to the inner ring diameter 260 in the range of 1.1 to 1.6. In a more preferred arrangement, the thickness ratio is in the range of 1.2 to 1.3.

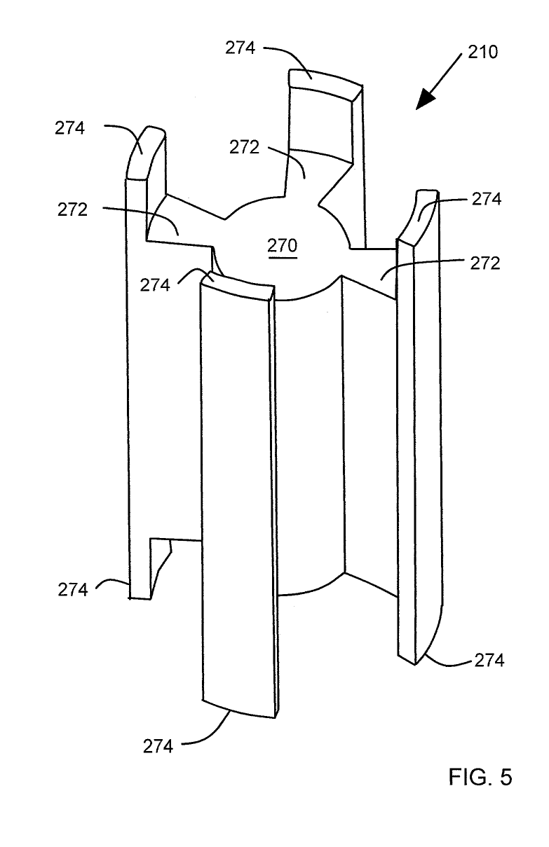

The yoke 210 is formed of metal, preferably stainless steel, and is mounted to a disk drive housing 264 that is formed of metal. The mounting of the yoke 210 to the disc drive housing 264 has a large enough surface area to effectively transfer, or sink, heat from the yoke 210 to the disc drive housing 264. The mounting is thus both a mechanical mounting and a thermal mounting, also called a heat sink. This arrangement provides good heat sinking for the coils 212. A screw 266 can be used to secure the yoke 210 to the housing 264 as illustrated. The yoke 210 is described in more detail below in connection with FIG. 5.

FIG. 5 illustrates the yoke 210 for the central stator assembly 208. The yoke 210 is preferably formed as a single integral part and is shaped to provide for two stator current loops. The yoke 210 includes a central cylindrical support core 270 and four symmetrically spaced radial fins 272. The radial fins 272 are each notched at the top and bottom as illustrated to permit coils to pass over the top and bottom ends without protruding beyond the castellated cylindrical ends 274 of the yoke 210. The bearings 222 (FIGS. 3-4) mount on the castellated cylindrical ends 274.

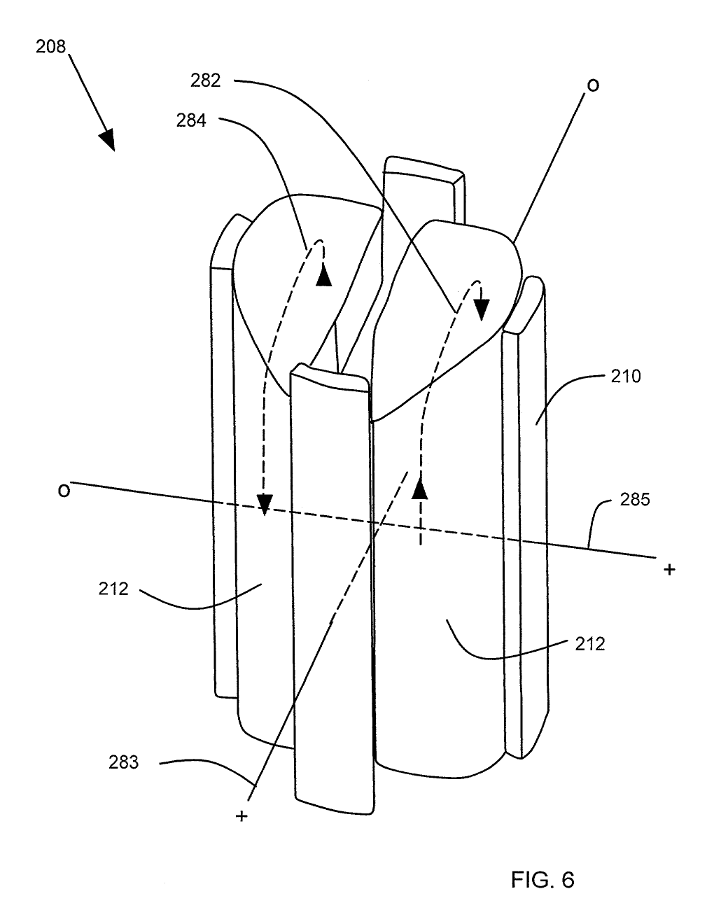

FIG. 6 illustrates the central stator assembly 208 including both the yoke 210 and coils 212. Dashed lines 282, 284 illustrate the relative direction of electric current flow (multiple stator current loops) in the coils 212. The central stator assembly 208 includes two stator current loop axes indicated by lines 283, 285.

FIG. 7 schematically illustrates a cross-sectional view of a 2-dipole rotor magnetic field of a permanent magnet ring such as the permanent magnet ring 218 illustrated in FIG. 4. The view in FIG. 7 is taken along a cross-sectional indicated by line 7-7′ in FIG. 4. The rotor dipole magnetic fields are a 2 dipole field and are depicted by arrows 290 with open arrowheads that indicate the direction, and an arrow lengths indicating relative magnitude of the magnetic field.

The permanent magnet ring 218 is formed of twelve permanent magnet segments 292. Each permanent magnet segment 292 is formed of magnetically hard material and is permanently magnetized in a direction indicated by arrows 294 that have a solid arrowhead. The coils 212 on the central stator assembly 208 provide two stator current loops and the permanent magnet ring 218 provides two rotor dipole magnetic fields. When a control current is passed through the coils 212, the rotor assembly 216 is subjected to magnetic forces that are symmetrical about a center axis and a true torque is generated that is substantially free of lateral reaction forces. The permanent magnet ring is illustrated with 12 segments 292, however, a larger number of segments, such as 24 segments or 36 segments can be used to obtain a more optimal rotor magnetic field distribution.

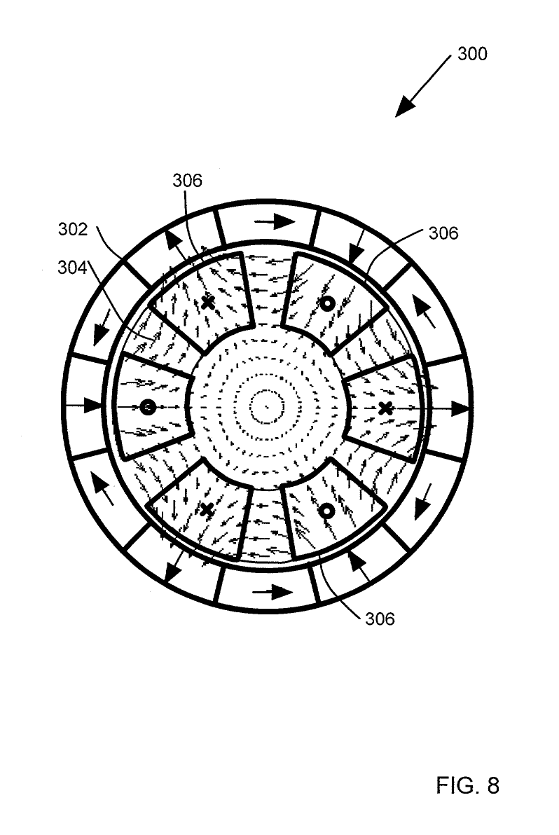

FIG. 8 illustrates a cross-sectional view of a magnetic field distribution in a 3 dipole motor 300. The arrangement illustrated in FIG. 8 is similar to the arrangement illustrated in FIG. 7, however, in FIG. 8 the permanent magnet ring 302 provides a 3-dipole rotor magnetic field as illustrated by arrows 304, and central stator includes 3 coils 306 that generate 3 stator current loops.

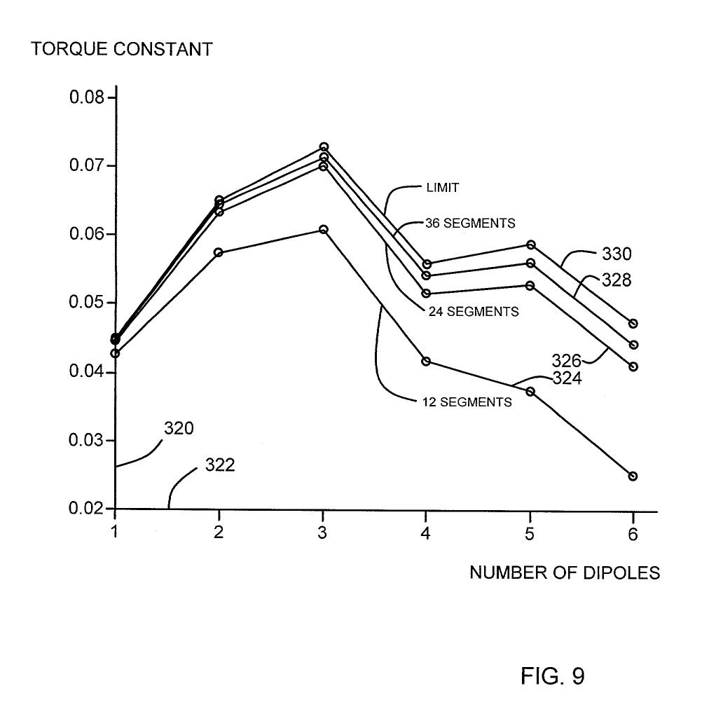

FIG. 9 illustrates variation of torque constants for dipole motors as a function of a number of dipoles and a number of magnet segments in the permanent magnet ring. In FIG. 9 a vertical axis 320 indicates a torque constant for the motor and horizontal axis 322 indicates a number of dipoles in the dipole motor. Predicted results are shown for permanent magnet rotors with 12 segments (line 324), 24 segments (line 326), 36 segment (line 328) and also a theoretical limit for an arbitrarily large number of segments (line 330). As can be seen from FIG. 9, more optimum torque factor results are obtained with 2 or 3 dipoles and with increasing numbers of segments. Further increasing the number of dipoles beyond 3 dipoles results in a deterioration of performance since the magnetic flux lines will divert tangentially before penetrating the actuator volume deep enough such that the coils would act upon them. The permanent magnet ring becomes increasingly complex to assemble as the number of segments increases, so larger numbers of segments can be contemplated for use when torque constants with smaller numbers of segments are inadequate for a particular application. There is likewise increasing difficulty in providing larger numbers of dipoles, and for many applications a 2 dipole rotor provides an optimum combination of an adequate torque constant and ease of assembly.

Increasing the torque constant of the actuator is a desirable feature. This is due to the fact that the seek times of the actuator (time required to move actuator from one track to another) decrease, and the gain of the plant being controlled in track following mode increases.

With the multiple dipole motor, an increased actuator torque constant is achieved for a given permanent magnet volume and number of coil windings. The increase is typically on the order of 30% to 50%. An optimal ratio of magnet inner to outer diameter is found to be near about 1.25. This ratio is relatively insensitive to other variations in the actuator parameter space.

Selection of the dimensions of various components of the motor can be completed by a two-dimensional “per unit length” analysis of torque constant. The analysis includes obtaining the magnetic field inside a segmented permanent magnet ring as a function of its geometrical parameters and number of dipoles. The analysis also includes integrating the cross product of the resulting radial magnetic field of the permanent magnet ring with the current density in the coils (stator current loops) to obtain the per unit length torque constant for the actuator. The analysis also includes comparing the performance of the actuators as the number of dipoles is varied as shown in FIG. 9.

The magnetic field inside the permanent magnet ring can be expressed as a Taylor series expansion about the center point. For a segmented multi-dipole array, the magnetic field is given by:

$${\underline{B}}^{*} ( \underline{{z}_{0}} ) = {B}_{rem} {\sum }_{v = 0}^{∞} {( \frac{\underline{{z}_{0}}}{{r}_{1}} )}^{n - 1} \frac{n}{n - 1} [ 1 - {( \frac{{r}_{1}}{{r}_{2}} )}^{n - 1} ] {K}_{n} \\ n = N + vM \\ {K}_{n} = {cos}^{n} ( \frac{δ π}{M} ) \frac{sin ( n δ π / M )}{n π / M} \\ \frac{n}{n - 1} [ 1 - {( \frac{{r}_{1}}{{r}_{2}} )}^{n - 1} ] {\vert}_{n = 1} = ln ( \frac{{r}_{1}}{{r}_{2}} ) \qquad Equations 1$$

where B is a complex number defining a magnetic field vector at a point;

Bᵣₑₘ is the remanence of magnets;

Z₀ is a complex number defining a vector to a point inside actuator;

r₁, r₂ are inner and outer magnet radii, respectively;

n is a number of dipoles in the stator (or rotor);

M is a number of permanent magnet segments per dipole;

Kn is a geometric factor accounting for shape of the magnet ring;

δ is a half angle of a magnet segment; and

* denotes complex conjugate.

Ideal Halbach arrays are those in which the direction of the magnetization vector changes continuously around the magnet ring. Such a configuration is difficult to approach physically, and can at best be approximated by a segmented magnet ring. The larger the number of segments, the better the approximation to the ideal case. The series collapse to a much simpler form with an ideal array. The estimate of actuator torque constant based on an ideal Halbach array serves as a good upper bound for comparing the performance of various designs as the number of dipoles are achieved:

$$\begin{matrix}{\underline{B}}^{*} ( \underline{{z}_{0}} ) = {( \frac{\underline{{z}_{0}}}{{r}_{1}} )}^{n - 1} {B}_{r} \frac{N}{N - 1} [ 1 - ( \frac{{r}_{1}}{{r}_{2}} ) ] for N \geq 2 & Equations 2 \\ {\underline{B}}^{*} ( \underline{{z}_{0}} ) = {B}_{r} ln ( \frac{{r}_{1}}{{r}_{2}} ) for N = 1 & Equations 3\end{matrix}$$

The forces generated in the actuator are obtained by computing the cross product of the radial component of the magnetic field and the coil cross-sectional area. This gives the forces generated as a function of location within the actuator volume. Integrating those forces and multiplying by the respective distance of action, an estimate of the torque constant of the actuator is obtained. This is given by the following expression:

$$τ = {\int }_{{α}_{S}}^{{α}_{E}} {\int }_{{r}_{o}}^{{r}_{i}} \frac{i \cdot l \cdot {ρ}_{c} \cdot {B}_{r} ( r , α )}{π \cdot {r}_{c}^{2}} ⅆ r \cdot ⅆ α \qquad Equations 4$$

where r is the radius;

α is the angle;

αₛ, α_{E} are start and end coil angles;

ri, ro are inner and outer coil radii respectively;

i is electrical current;

l is the active length of actuator;

ρ_{c} is the coil packing density;

r_{c} is the coil radius;

Bᵣ is the magnetic field in the radial direction.

The expression is integrated numerically using direct methods, and is used to compute the torque generated by the actuator.

In a disc drive, a disc has a disc surface that has a rotary motion about a disc axis. A head assembly has a head that has a head motion that typically includes a radial component relative to the disc axis. The rotary motion and the head motion interact to provide a combined relative motion between the head and the disc surface so that the head accesses an area the disc surface. A motor, such as the multiple dipole motors described above in connection with FIGS. 3-9, can be used to control or provide a portion of the combined relative motion in the disc drive. The multiple dipole motor can replace a voice coil motor, as illustrated. The multiple dipole motor can also be used in head testers for disc drives and for controlling servo track writing during the manufacture of discs for disc drives.

In summary, a disc drive (such as 200) includes a motor (such as 201) that positions a head assembly (such as 202) on a disc surface (such as 106). The motor (such as 201) comprises a central stator assembly (such as 208) that includes coils (such as 212, 306) arranged on a yoke (such as 210). The central stator assembly (such as 208) provides multiple stator current loops (such as 282, 284) on the central stator assembly (such as 208). The motor also comprises a rotor assembly (such as 216) that includes a permanent magnet ring (such as 218). The permanent magnet ring (such as 218) is rotatably arranged around the central stator assembly (such as 208) and provides multiple rotor dipole magnetic fields (such as 290, 304) inside the permanent magnet ring (such as 218). The motor includes a beam (such as 220) coupled between the permanent magnet ring (such as 218) and the head assembly (such as 202).

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the pattern of the coil windings may vary depending on the particular application for the disc drive while maintaining substantially the same field pattern without departing from the scope and spirit of the present invention. In addition, although the preferred embodiment described herein is directed to a head positioning motor for a magnetic storage system, it will be appreciated by those skilled in the art that the teachings of the present invention can be applied to other systems, like optical or magneto-optic systems, without departing from the scope and spirit of the present invention.

What is claimed is:

1. A disc drive, comprising:
a disc having a disc surface;
a head assembly having a head accessing the disc surface and a strut extending from a strut proximal end to a strut distal end that engages the head; and
a motor comprising:
a central stator assembly comprising a yoke and coils arranged on the yoke as multiple stator current loops on the central stator assembly; and
a rotor assembly including a permanent magnet ring that is rotatably arranged around the central stator assembly and that provides multiple rotor dipole magnetic fields crossing the current loops; and including a beam coupled between the permanent magnet ring and the strut proximal end.

2. The disc drive of claim 1, further comprising:
a bearing that rotatably supports the rotor assembly on the central stator assembly.

3. The disc drive of claim 1 wherein the permanent magnet ring is a Halbach ring.

4. The disc drive of claim 1 wherein the magnetically hard material is selected from the group of alloys: neodymium iron boride alloy, samarium cobalt alloy, platinum cobalt alloy and samarium cobalt alloy.

5. The disc drive of claim 1 wherein the yoke is formed of stainless steel.

6. The disc drive of claim 1 wherein the rotor assembly further comprises a counterweight that rotationally balances the rotor assembly.

7. The disc drive of claim 1 further comprising a mechanical stop that engages the rotor assembly at first and second rotational movement limits.

8. The disc drive of claim 7 wherein the rotational movement limits are spaced apart 30 degrees or less.

9. The disc drive of claim 1 wherein the permanent magnet ring has an inner ring diameter and an outer ring diameter and a thickness ratio of the outer ring diameter to the inner ring diameter is in the range of 1.1 to 1.6.

10. The disc drive of claim 8 wherein the thickness ratio is in the range of 1.2 to 1.3.

11. The disc drive of claim 1, further comprising:
a disk drive housing formed of metal; and the yoke is formed of metal and is in thermal contact with the disk drive housing.

12. The disc drive of claim 1 wherein the rotor assembly further comprises a magnetic shielding layer surrounding the permanent magnet ring.

13. The disc drive of claim 1 wherein the permanent magnet ring comprises multiple segments of magnetically hard material.

14. The disc drive of claim 1 wherein the central stator assembly provides two stator current loops and the permanent magnet ring provides two rotor dipole magnetic fields.

15. The disc drive of claim 1 wherein the central stator assembly provides three stator current loops and the permanent magnet ring provides three rotor dipole magnetic fields.

16. The disc drive of claim 1 wherein the permanent magnet ring comprises at least 12 segments.

17. A method of making a disc drive, comprising:
providing a disc having a disc surface;
providing a head assembly having a head accessing the disc surface and a strut extending from a strut proximal end to a strut distal end that engages the head; and
forming coils around a yoke to produce a central stator assembly providing multiple stator current loops on the central stator assembly; and
rotatably arranging a rotor assembly including a permanent magnet ring around the central stator assembly to provide multiple rotor dipole magnetic fields crossing the current loops; and
providing a beam coupled between the permanent magnet ring and the strut proximal end.

18. The method of claim 17, further comprising:
supporting the rotor on the central stator assembly with a bearing.

19. The method of claim 17, further comprising:
forming the yoke of stainless steel.

20. The method of claim 17, further comprising:
rotationally balancing the rotor assembly with a counterweight.

21. The method of claim 17, further comprising:
engaging the rotor assembly with mechanical stops at first and second rotational movement limits.

22. The method of claim 17, further comprising:
mounting the yoke to a disk drive housing formed of metal to provide thermal contact between the yoke and the disc drive housing.

23. The method of claim 17, further comprising:
segmenting the permanent magnet ring with multiple segments of magnetically hard material.

24. A disc drive, comprising:
a disc having a disc surface; a head assembly having a head accessing the disc surface and a strut extending from a strut proximal end to a strut distal end that engages the head; and
means for positioning the head assembly.

25. An apparatus, comprising:
a disc having a disc surface that has a rotary motion about a disc axis;
a head assembly having a head that has a head motion relative to the disc axis, the rotary motion and the head motion interacting to provide a combined relative motion between the head and the disc surface so that the head accesses an area the disc surface; and
a motor comprising:
a central stator assembly comprising a yoke and coils arranged on the yoke as multiple stator current loops on the central stator assembly; and
a rotor assembly including a permanent magnet ring that is rotatably arranged around the central stator assembly and that provides multiple rotor dipole magnetic fields crossing the current loops, a rotation of the rotor controlling a portion of the combined relative motion.

26. The apparatus of claim 25 wherein the permanent magnet ring is a Halbach ring.

27. The apparatus of claim 25 further comprising a mechanical stop that engages the rotor assembly at first and second rotational movement limits.

28. The apparatus of claim 27 wherein the rotational movement limits are spaced apart 30 degrees or less.
